(19) United States
(12) Patent Application Publication
(10) Pub. No.: US 2021/0240859 A1
(43) Pub. Date: Aug. 5, 2021

(54) IMMUTABLE DOWNLOADS

(71) Applicant: AIO ME LTD., Tel-Aviv (IL)

(72) Inventors: Yuval RYABOY, Nesher (IL); Yoram BECHLER, Givatayim (IL)

(73) Assignee: AIO ME LTD., Tel-Aviv (IL)

(21) Appl. No.: 17/166,408

(22) Filed: Feb. 3, 2021

Related U.S. Application Data
(60) Provisional application No. 62/969,943, filed on Feb. 4, 2020.

(51) Int. Cl. G06F 21/64; G06F 8/61; G06F 16/958

(52) U.S. Cl. CPC G06F 21/64; G06F 16/958; G06F 8/61

(57) ABSTRACT

A method, product and system for providing immutable downloads. The method comprises downloading a document from a source to a device. In response to a determination that the document was downloaded, calculating a signature of the document. The signature is deposited to a repository and may be utilized to compare with a second signature of the document to ensure that the document was not modified.

### CROSS-REFERENCE TO RELATED APPLICATION

This application claims the benefit of provisional patent application No. 62/969,943, entitled “Immutable Downloads” filed Feb. 4, 2020, which is hereby incorporated by reference in its entirety without giving rise to disavowment.

### TECHNICAL FIELD

The present disclosed subject matter relates to provisioning of digital documents and files. More particularly, the present disclosed subject matter relates to provisioning of digital documents and files in a manner preventing modification thereof or otherwise tampering therewith.

### BACKGROUND

Presently the way users manage, store, and share digital information or documents online has problems. Risk, headache, and cost to both consumers and businesses are rising. Businesses requesting documents spend millions on getting data traffic to their digital channels but during the onboarding process more than 50% abandon. It soars up to 80% abandonment if asked to supply a document such as tax returns, utility bills, proof of address, diplomas, or the like. In the case of unsecured loans 30% of those who do continue with data transfer and almost complete the process drop at the last few steps when asked to give away their login and password to their checking account or accounting software.

Slow, expensive, and sometimes semi-manual verification processes result in loss of business. Such commercially available verification process leads to reduced usability of systems and poor user experience in the usage of technological devices.

### BRIEF SUMMARY

One exemplary embodiment of the disclosed subject matter is a method comprising: downloading a document from a source to a device; in response to a determination that said downloading of the document is completed, calculating a signature of the document; and depositing the signature to a server, whereby any modification to the document is identifiable using the signature that is retained by the server.

Optionally, the device is a mobile device retaining a mobile application, wherein said downloading is performed using an in-app browser of the mobile application.

Optionally, the method comprises authenticating the document using a parameter of the source, wherein the parameter is selected from the group consisting of: a parameter of a Secure Socket Layer (SSL) of the source utilizing in said downloading; a parameter of a Hypertext Markup Language (HTML) document from which said downloading is initiated; and a parameter of screenshots of a webpage from which said downloading is initiated.

Optionally, the device is a mobile device retaining a mobile application, wherein the method further comprises: in response to a determination that a valid external-application is not available on the mobile device for performing said downloading, utilizing an in-app browser of the mobile application for performing said downloading.

Optionally, the method comprises authenticating the download process, wherein said authenticating comprises: obtaining one or more expected parameters of the download process; obtaining one or more parameters of the download process; and verifying that the one or more parameters match the one or more expected parameters.

Optionally, the device is a mobile device retaining a mobile application, wherein the method further comprises: determining, by the mobile application, that an external-application is installed on the mobile device, wherein the external-application is different than the mobile application, wherein said determining is based on a list of allowed external-applications; in response to said determining, validating the external-application; and in response to successful validation of the external-application utilizing the external-application for performing said downloading.

Optionally, said validating the external-application is based on at least one of: an application repository from which the external-application was retrieved to the mobile device; parameters of an Application Package (APK) of the external-application; and a signature of the external-application.

Optionally, the method further comprising: initiating monitoring of activity in the mobile device using one or more services of an operating system of the mobile device, wherein the monitoring activity comprises: recording application at foreground of the mobile device and times thereof; identifying time of start of downloads in the mobile device; and determining which application was at the foreground when said downloading was started to verify that said downloading was initiated by the external-application.

Optionally, the determination that said downloading of the document is completed is determined based on monitoring FileObserver status.

Optionally, the device is a mobile device retaining a mobile application, the method further comprises: selecting downloading method between an in-app based-downloading method and an external-application-based downloading method, wherein the in-app based-downloading method comprises downloading the document using an in-app browser of the mobile application, wherein the external-application-based method comprises downloading the document using an external-application that is external to the mobile application, wherein said selecting is based on a prediction of expected successful completion time using each alternative downloading method.

Optionally, said selecting is performed using a predictor, wherein the predictor is based on historic outcomes of past downloading attempts, wherein the method further comprises transmitting information to a remote server for gathering training dataset for training the predictor using supervised machine learning.

Optionally, the server is a distributed ledger, whereby the signature is accessible without requiring authorization of a central administrator.

Another exemplary embodiment of the disclosed subject matter is a system comprising: a server comprising a memory unit; at least one mobile device, each of which comprising a processor and a memory unit; and a client device comprising a processor; wherein said at least one mobile device utilizing a mobile application for obtaining a signature of a document at a time in which the downloading of the document is completed, wherein the mobile application is configured to send the signature to the server to be retained therein; wherein said client device is configured to obtain a second signature of a document received from said at least one device; and wherein the system is configured to compare the signature with the second signature to verify that the document was not modified.

Optionally, the mobile application is configured to download the document using an in-app browser of the mobile application, wherein the mobile application is configured to verify authenticity of the document based on one or more parameters relating to a source of the document from which the document is downloaded.

Optionally, said at least one mobile device retaining an external-application external to the mobile application, wherein the external-application is provided by a publisher independent of a publisher of the mobile application, wherein the mobile application is configured to utilize one or more services of an operating system to monitor activity at said at least one mobile device to verify that the external-application is used to download the document.

Optionally, the mobile application is configured to utilize the one or more services of the operating system to: identify and record application at foreground of said at least one mobile device and times thereof; identifying time of start of downloads in said at least one mobile device; wherein the mobile application is configured to determine which application was at the foreground when said downloading was started to verify that said downloading was initiated by the external-application.

Yet another exemplary embodiment of the disclosed subject matter is a mobile application comprising a non-transitory computer readable medium retaining program instructions, which instructions when read by a processor of a mobile device, cause the processor to perform: in response to a determination a downloading of a document is completed, calculating a signature of the document; and depositing the signature to a server, whereby any modification to the document is identifiable using the signature that is retained by the server.

Optionally, the mobile application comprising an in-app browser, wherein the in-app browser is utilized to download the document from a source.

Optionally, the program instructions, when read by the processor, cause the processor to perform: selecting downloading method between an in-app based-downloading method and an external-application-based downloading method, wherein the in-app based-downloading method comprises downloading the document using an in-app browser of the mobile application, wherein the external-application-based method comprises downloading the document using an external-application that is external to the mobile application, wherein said selecting is based on a prediction of expected successful completion time using each alternative downloading method.

Optionally, the program instructions, when read by the processor, cause the processor to perform: determining that an external-application is installed on the mobile device, wherein the external-application is different than the mobile application, wherein said determining is based on a list of allowed external-applications; in response to said determining, validating the external-application, wherein said validating the external-application is based on at least one of: an application repository from which the external-application was retrieved to the mobile device; parameters of an Application Package (APK) of the external-application; and a signature of the external-application; and in response to successful validation of the external-application utilizing the external-application for performing said downloading.

### BRIEF DESCRIPTION VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure.

In the drawings:

FIG. 1 shows a block diagram of a downloading system, in accordance with some exemplary embodiments of the disclosed subject matter;

FIG. 2 shows a flowchart diagram of a method, in accordance with some exemplary embodiments of the disclosed subject matter;

FIG. 3 shows a flowchart diagram of a method, in accordance with some exemplary embodiments of the disclosed subject matter;

FIG. 4 shows a flowchart diagram of a method, in accordance with some exemplary embodiments of the disclosed subject matter;

FIGS. 5A-5D show screenshots of a portal application, in accordance with some exemplary embodiments of the disclosed subject matter; and

FIGS. 6A-6D show screenshots of a user's device, in accordance with some exemplary embodiments of the disclosed subject matter.

### DETAILED DESCRIPTION

One technical problem dealt with by the disclosed subject matter is the lengthy, unsafe, and cumbersome process involving communicating digital documents, issued by a third party, between different types of users.

Another technical problem dealt with by the disclosed subject matter is the securement of the authenticity of documents during downloading them from a third-party source and communicating them to a documents' requester, by a user. It may be desired to ensure that the documents are not altered.

Yet another technical problem dealt with by the disclosed subject matter is that institutions, such as banks or insurance companies, requesting documents from their clients or other entities may desire to utilize a platform for managing digital document upload by clients and other entities.

One technical solution is providing users with an Immutable Download Application (ID-Application) adapted to be installed on a personal computing device such as a smartphone, a tablet computer, a Personal Digital Assistant (PDA), a Personal Computer (PC), or the like. In some exemplary embodiments, the ID-Application may be installed on a personal computing device utilizing a sandbox-based operating system, such as iOS™, ANDROID™, or the like. In some exemplary embodiments, ID-Application allows users to directly connect to a website of a third-party entity, such as a University, a Bank, the Census Bureau, or the like, for directly downloading documents associated with the user, to be provisioned to a documents' requester (such as the institute).

In some exemplary embodiments, ID-Application may monitor the download process making sure that the document source (i.e., a third-party web-server) is authentic. Additionally or alternatively, ID-Application may extract a signature based on the content of the document at the time it was downloaded and received, so as to identify any potential modification of the document thereafter.

In some exemplary embodiments, ID-Application may utilize an in-app-browser to perform the downloading while collecting metadata of the document for validating the document authenticity. The in-app browser may be a module implemented within ID-Application, enabling the ID-Application to present a webpage from a Uniform Resource Locator (URL). In some exemplary embodiments, the in-app browser may be devoid of an address field, preventing the user of the ID-Application from freely navigating to desired webpages, and instead relying on an initial URL to which the ID-Application directed the in-app browser, and to pages connected therewith traversed to using hyperlinks within the pages.

Additionally, or alternatively, ID-Application may invoke an external-application of a source, if available, for downloading the document. For example, in case of a third-party source being a Bank, the Bank may have a proprietary designated application provided to its clients, that can be used to download documents. It is noted that the disclosed subject matter may be employed without establishing an Application Programming Interface (API) or other direct connectivity between the external-application and the ID-Application. The external-application may be a dedicated application related to the relevant source and may not be a generic application, such as a generic internet browser capable of accessing various webpages based on user definitions and instructions.

In some exemplary embodiments, ID-Application may monitor and record statuses and indications during the downloading process used for determining the authenticity of the document. In some exemplary embodiments, ID-Application may monitor which application is at the foreground of the device. By monitoring activity at the foreground, and recording which application was at the foreground at each timeframe, correlating download activity that was initiated during a specific timeframe with the relevant application can be performed. In some exemplary embodiments, ID-Application may monitor, using services of the Operating System (OS) of the mobile device, when files are starting to be downloaded. After a pertinent document starts to be download, and to reduce potential loss of privacy, the monitoring of the applications in the foreground may be stopped. In some exemplary embodiments, using services of the OS, the ID-Application may monitor to determine when the download is completed successfully. In response to such determination, a signature of the downloaded document may be extracted immediately and utilized to ensure that once the document is provided to the documents' requester, the provided document is unmodified.

In some exemplary embodiments, the in-app-browser and the external-application downloading options may both be available, such as when an external-application that is trusted is available on the mobile device and when there is a known URL from which the document can be downloaded using the in-app browser. In some exemplary embodiments, the ID-Application may select an option having the highest probability of performing the download in the most reliable and effective way may be the preferred option. In some exemplary embodiments, the selection may be based on a prediction on likelihood of completion of the downloading process, e.g., as opposed to user churning from the process. Additionally or alternatively, the selection may be based on a prediction of the time it will take the user to commence the download. Based on the predicted timing, the option that is expected to be more convenient to the user may be selected, thereby improving the user's User eXperience (UX). In some exemplary embodiments, for selecting the preferred option therebetween, ID-Application utilizes Artificial Intelligence (AI), machine learning, deep learning, or the like, which may be based on historic downloading attempts and based on past users' activities that may be reported by different instances of the ID-Application.

In some exemplary embodiments, ID-Application may generate a digital signature for successfully authenticated downloaded documents. The digital signature may be transmitted to a server for safe keeping, such as a centralized data repository, a distributed ledger, or the like. In some exemplary embodiments, ID-Application may upload the document to documents' requester. In order to verify that the document was not modified by the user after being downloaded, a signature of the uploaded document may be generated and compared with the stored digital signature that was obtained when the document was downloaded.

In some exemplary embodiments, authenticated documents may be managed, and stored by ID-Application in a user's dedicated repository (e.g., vault) for future use, and for provisioning to the documents' requester.

Another technical solution is providing document requesters, such as mortgage banks, insurance companies, employers, or the like, with a Portal application for managing digitally obtained documents, also referred to as Portal. In some exemplary embodiments, Portal may provide users with a link for downloading the ID-Application of the present disclosure. Alternatively, Portal may direct users to an application store from which ID-Application of the present disclosure can be downloaded.

In some exemplary embodiments, Portal may be configured to interface with the user's ID-Application for specifying requested documents. Additionally, or alternatively, Portal may indicate to users, via ID-Application, a preferred link from which website the document can be downloaded. In some exemplary embodiments, the documents' requester may configured parameters, rules and configurations for the downloaded document, such as indicating which documents are to be provisioned, what external-applications are allowed to be used, from which webpage the documents can be downloaded, or the like.

Yet another technical solution is providing an Immutable Downloads Server (ID-Server) adapted for orchestrating a downloading-system for managing documents without permitting them to be changed after being downloaded (immutable download). In some exemplary embodiments, the ID-Server may be utilized to validate current digital signature of a document with an expected signature obtained at the time the document was downloaded.

In some exemplary embodiments, ID-Server may be configured to collect from ID-Application(s) metadata and other parameters of each downloaded document. In some exemplary embodiments, ID-Server may assist ID-Application in determining a document authenticity by providing pre-stored parameters of the website from which the document was downloaded so that ID-Application could examine the metadata with excepted parameters.

In some exemplary embodiments, ID-Server may retain metadata and parameters information of each examined document. This information may be used for responding to a Portal's signature validation query.

In some exemplary embodiments, ID-Server may utilize retained information about the documents, pre-stored website parameters, and statistics information obtained from a plurality of ID-Applications for executing machine/deep learning algorithms used for determining preferred download method by ID-Application.

In some exemplary embodiments of the disclosed subject matter, ID-Application and Portal may be agnostic to the operating system. For example, the ID-Application may be a cross-platform mobile application that utilizes an in-app browser. Additionally or alternatively, the Portal may be implemented using web-technology, which may be cross-platform. Additionally or alternatively, the ID-Application may be platform specific and utilize specific services of the Operating System of the mobile device.

One technical effect of utilizing the disclosed subject matter is alleviating users and businesses in the process of digitally submitting authenticated documents. The immutable download platform of the present disclosure may guarantee that documents obtained from third-parties via a digital connection remain unchanged without involving the source provider (third-party), even in case the documents were downloaded by an untrusted party who may have an interest in modifying their content (e.g., the user).

Another technical effect of utilizing the disclosed subject matter put users in control through verified identities, grounded in user consent, control, and privacy. Additionally, or alternatively, the solution of the present disclosure helps users collect, organize, submit, and control their data and documents throughout their digital life. Users may have their data whenever they need it and they own it.

Yet another technical effect of utilizing the disclosed subject matter facilitates the process of submitting and processing certified documents for both customers (users) and business workers.

The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

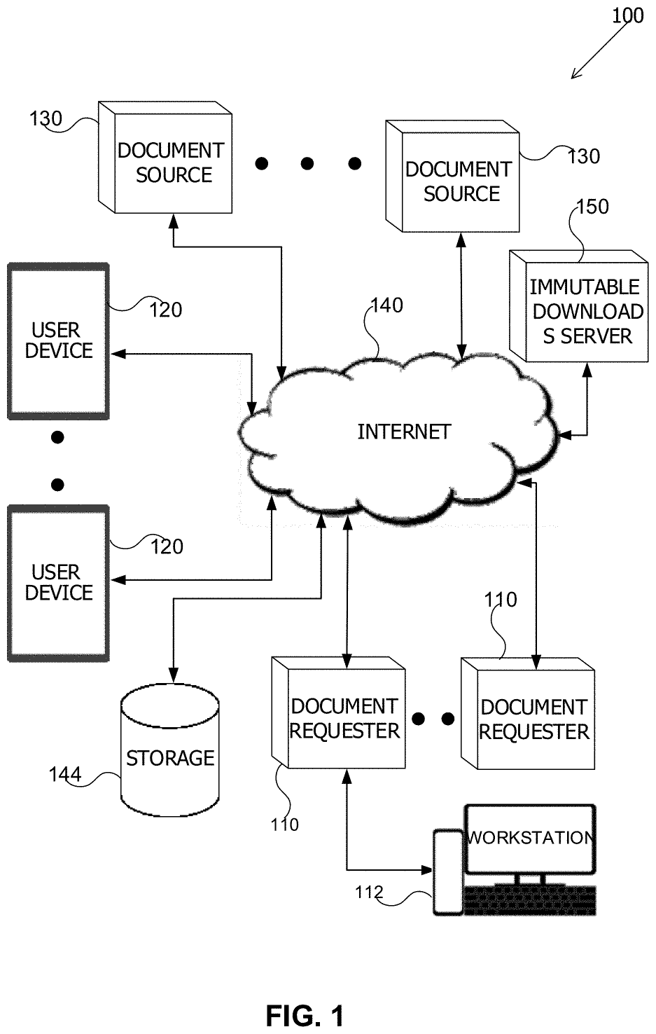

Referring now to FIG. 1 showing a block diagram of a downloading system, in accordance with some exemplary embodiments of the disclosed subject matter. Downloading-System 100 is a client-server system adapted for downloading and managing documents without any change during downloading and sending them, i.e., immutable download.

Downloading System 100 may comprise at least one Immutable Downloads Server (ID-Server) 150, at least one user's device (Device) 120, at least one Document Source (Source) 130, at least one Document Requester (Requester) 110, all connected by a Network 140, such as the Internet, an intranet, a WiFi network, a Local Area Network (LAN), a Wide Area Network (WAN), or the like. In alternative configurations, different and/or additional modules may be included in the system.

In some exemplary embodiments, Device 120 comprise computing components that can receive user input and can transmit and receive data via Network 140. For example, Device 140 may be a desktop computer, a laptop computer, a smartphone, a cell phone, a personal digital assistant (PDA), or any other device including computing functionality and data communication capabilities. In some exemplary embodiments, Device 120 may be configured to communicate, via Network 140, with any one of the network elements of Downloading-System 100. It will be appreciated that Device 120 data communication capabilities may comprise any combination of LAN and WAN, using wired communication systems, wireless communication systems, or the like.

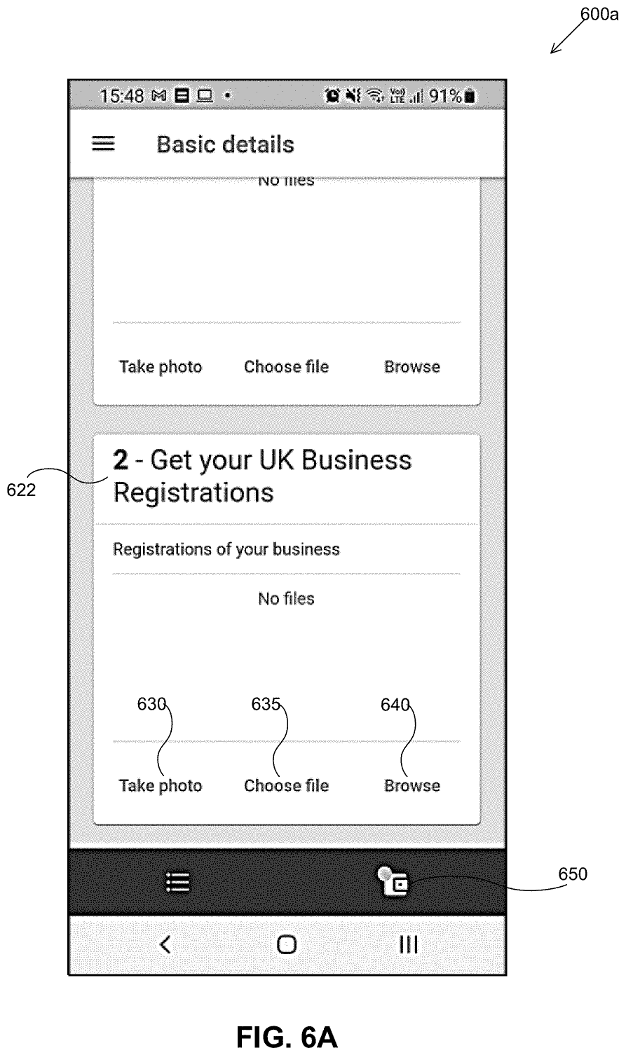

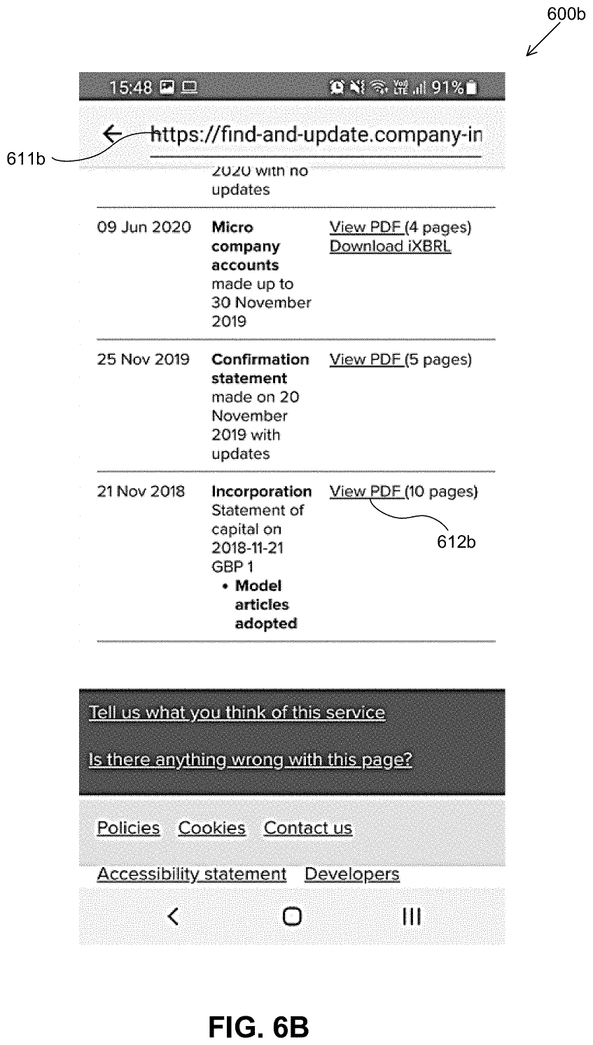

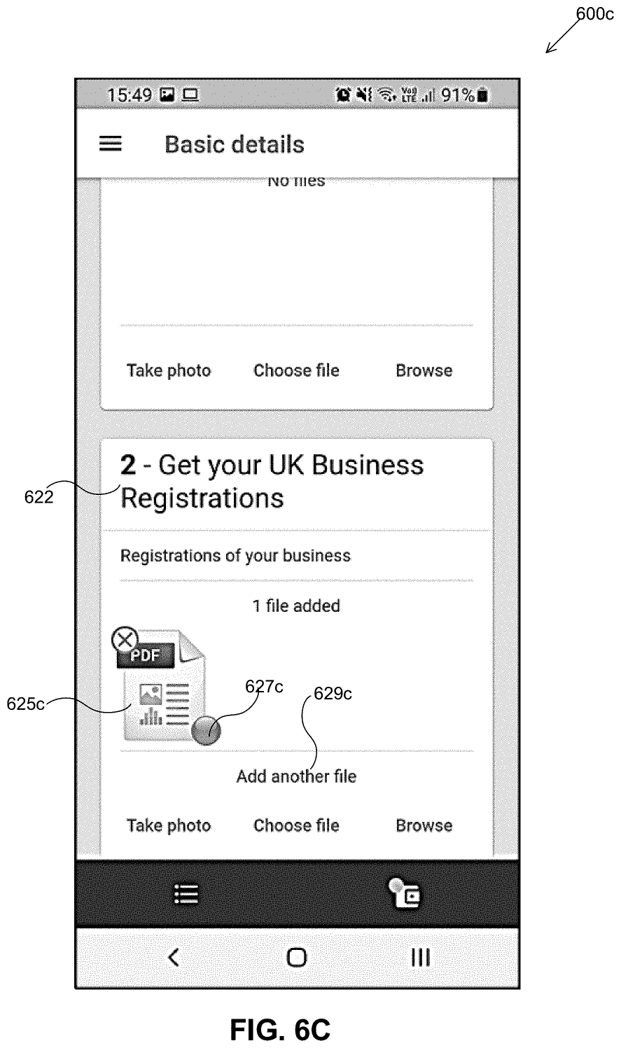

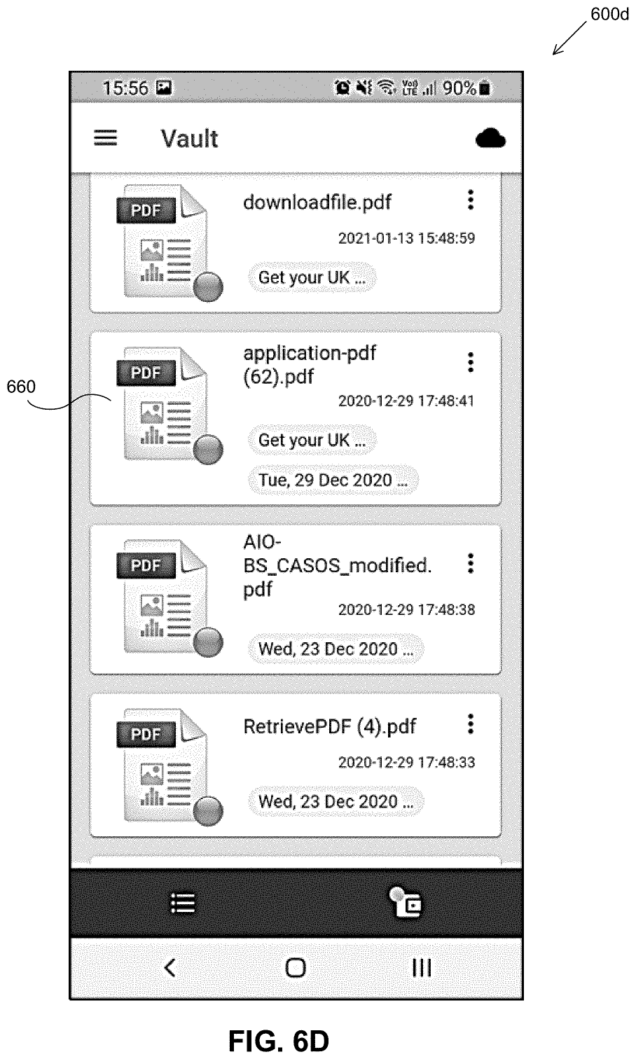

In some exemplary embodiments, Device 120 may comprise a touchscreen, or other user-input device and output device, to provide users with visualized graphic user interface (GUI), such as screenshots depicted in FIGS. 6A-6D, to receive input from users, or the like.

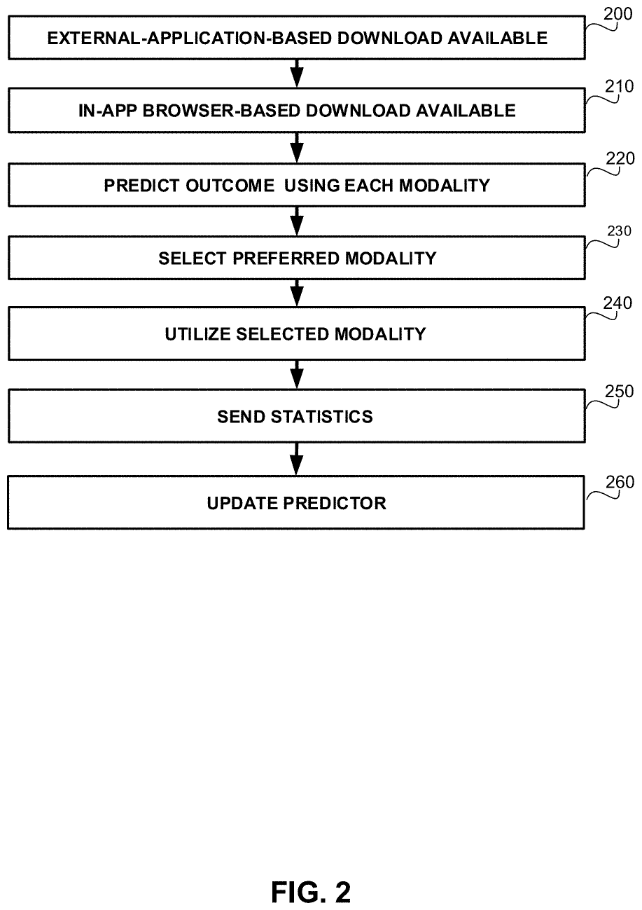

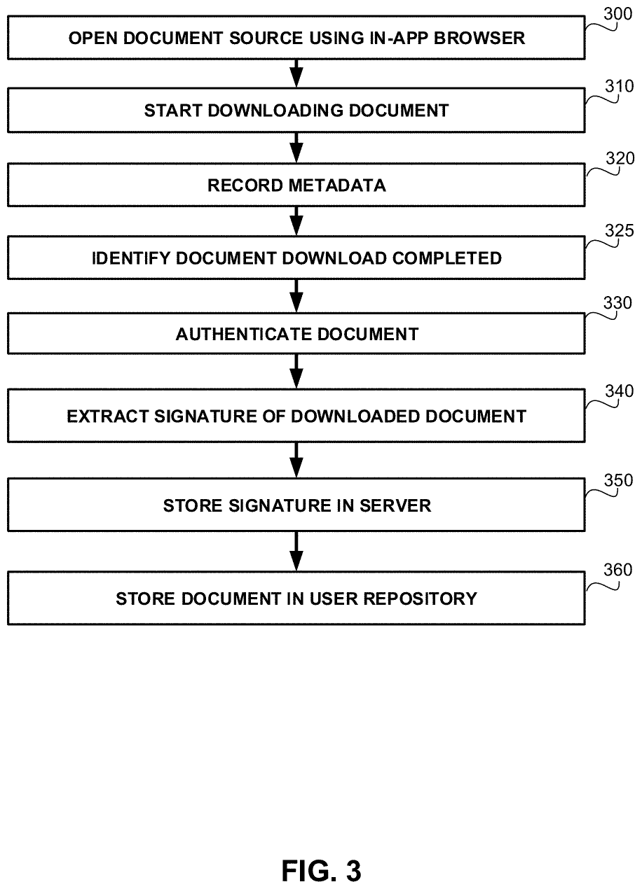

In some exemplary embodiments, Device 120 may comprise a memory unit (not shown). The memory unit may retain program code operative to cause Device 120 to perform acts associated with any of its subcomponents. In some exemplary embodiments, memory unit may retain program code and application, such as Immutable Download Application (ID-Application) of the present disclosure (to be described in detail further below), operative to cause Device 120 to perform acts associated with any of the steps in FIG. 2-3, or the like.

In some exemplary embodiments, Source 130 may be a web-server hosting a group of World Wide Web (WWW) pages of third-party entities, such as educational institutions, government branches, organizations, or the like. Source 130 may store information, records, and documents, such as birth certificates, bank records, car registration, or the like. In some exemplary embodiments, Source 130 may be used as a data repository made available online by the third-party entity.

In some exemplary embodiments, Source 130 enables users, of devices such as Device 120, to retrieve (download) documents or other information associated with the users after authenticating the users' identity. In some exemplary embodiments, Device 120 comprising ID-Application (to be described in detail further below) may access Source 130 via Network 140 for downloading documents using either an in-app browser or a dedicated external-application of Source 130.

In some exemplary embodiments, after the download of a document from Source 130 is completed, the downloaded document may be retained in a local storage in Device 120. Additionally or alternatively, the document may be transferred to a Storage 144, such as a user-owned data storage, a cloud storage, a local server, or the like.

In some exemplary embodiments of the disclosed subject matter, Requester 110 may comprise at least one server or at least one client, such as Workstation 112, a combination thereof, or the like. In some exemplary embodiments, Requester 110 may utilize a client-server model configured to provide database services, documents server services, web server services, application server services, and any combination thereof, or the like.

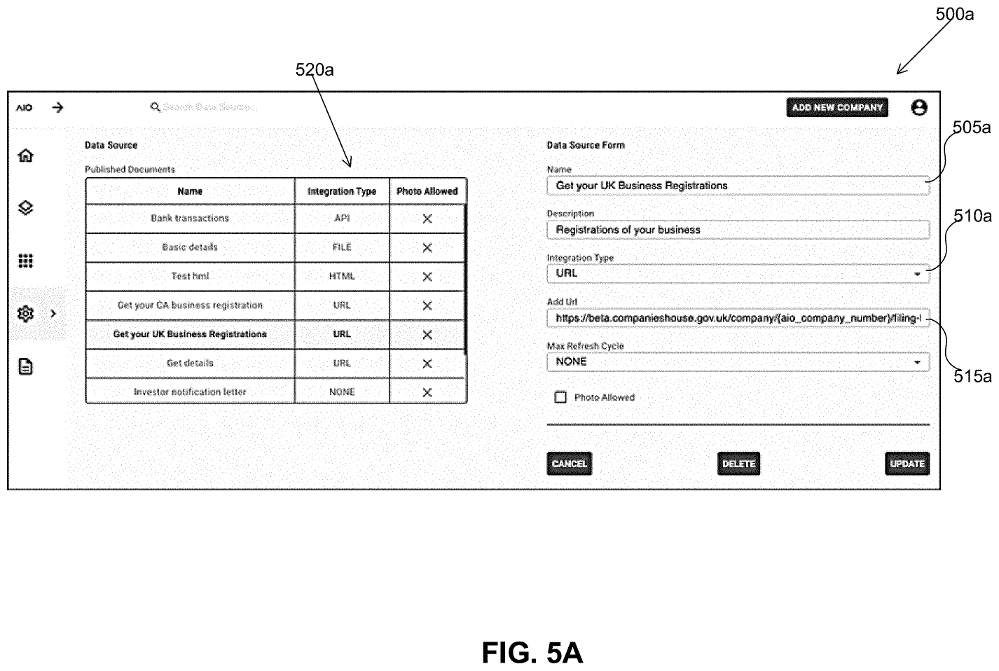

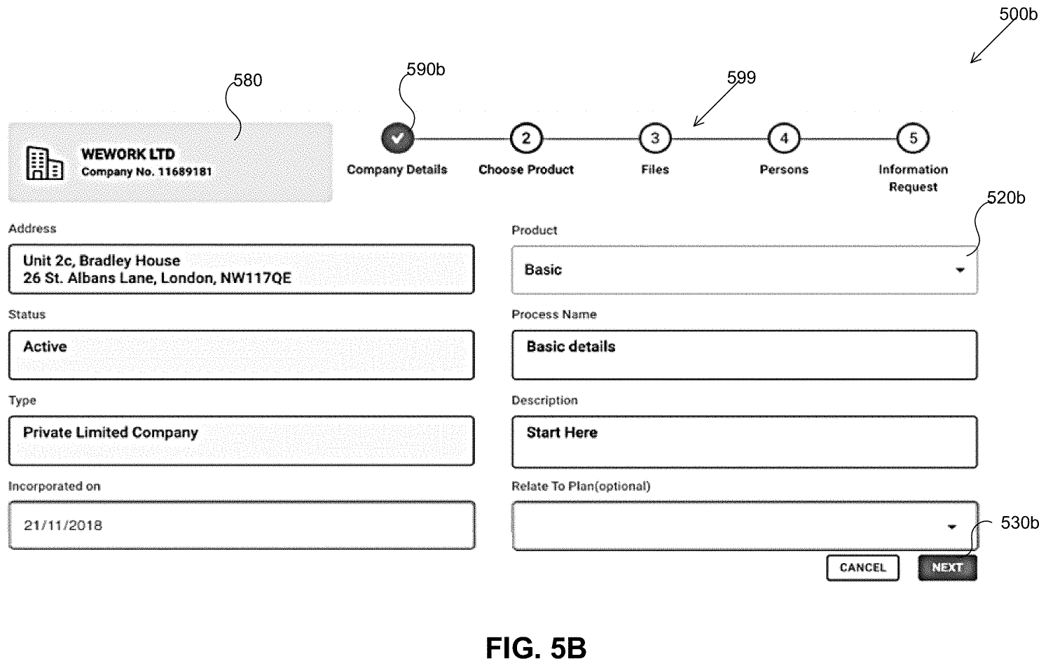

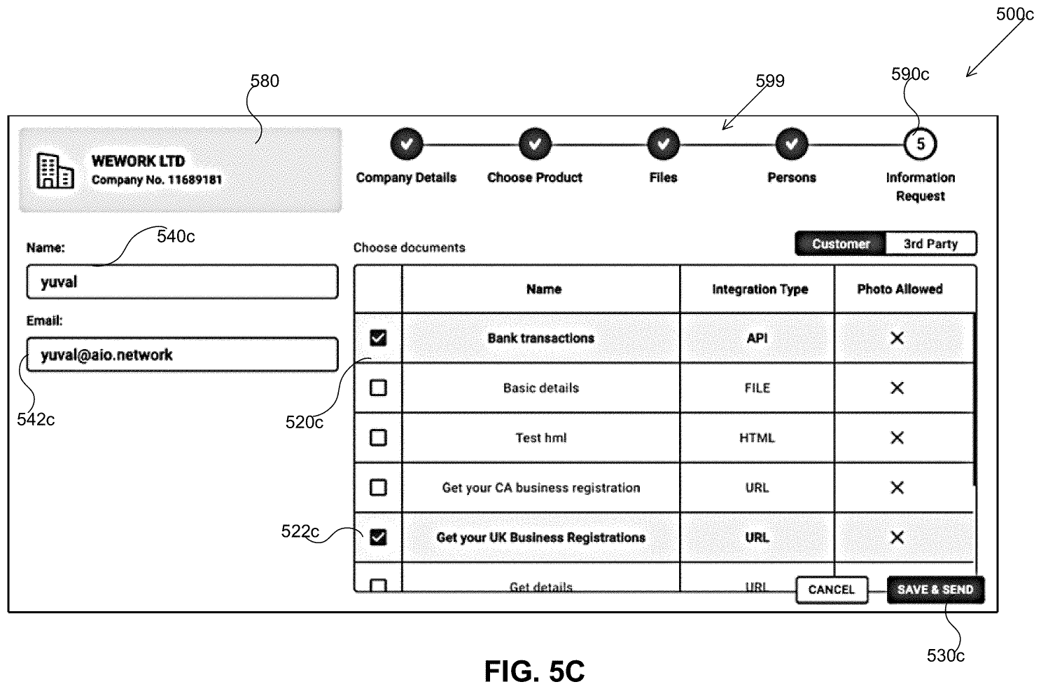

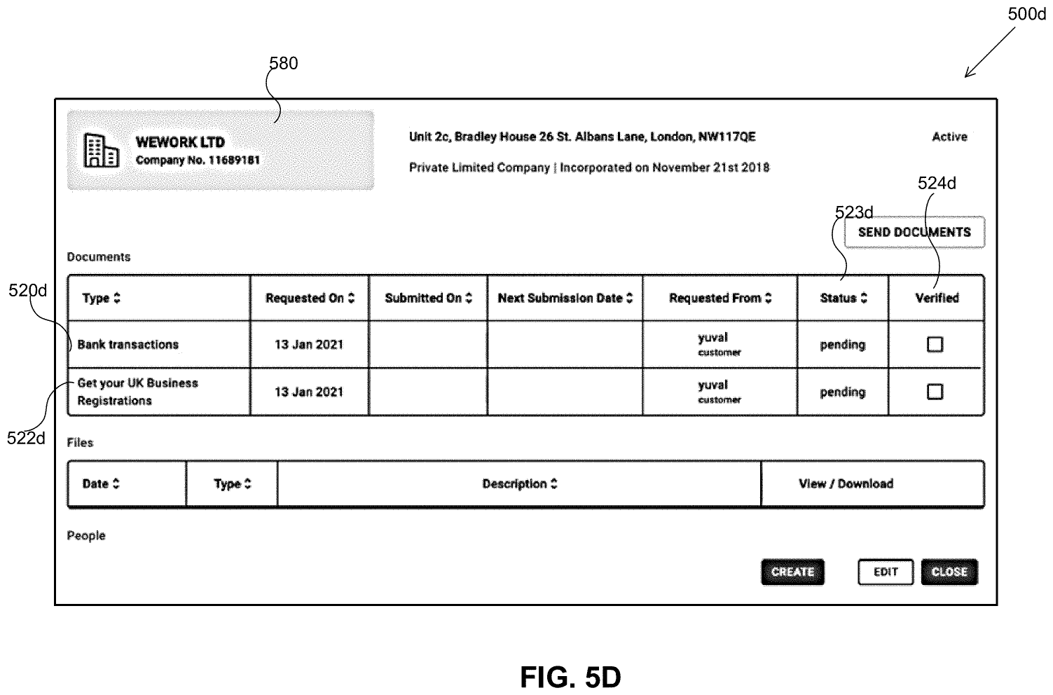

In some exemplary embodiments, Requester 110 may retain program code operative to perform acts associated with any of its subcomponents. In some exemplary embodiments, Requester 110 may retain program code and application, such as a Portal software application (Portal) of the present disclosure, operative to cause Requester 110 to perform acts associated with any of the steps in FIG. 2-3, or the like. In some exemplary embodiments, Requester 110 may be able to communicate with a plurality of Devices 120 and ID-Server 150 via Network 140. In some exemplary embodiments, Workstation 112 may comprise a screen to provide users with visualized interface, such as screenshots depicted in FIGS. 5A-5D.

Requester 110 may be used by businesses, such as mortgage banks, insurance companies, employers, universities, or the like. In some exemplary embodiments, Requester 110 may be utilized for requesting and obtaining documents from users required for processing the users' application, such as mortgage loans, employment applications, university applications, or the like.

In some exemplary embodiments, Portal may be configured for requesting, obtaining, and managing digital documents. In some exemplary embodiments, Portal may be provided with a User Interface (UI) for assisting operators in managing information associated with the digital documents.

In some exemplary embodiments, Portal may provide users of Device 120 with a link for downloading the ID-Application of the present disclosure. Additionally, or alternatively, Portal may direct Device 120 users to an application store from which the ID-Application of the present disclosure can be downloaded.

In some exemplary embodiments, Portal may allow a user, such as via Workstation 112, to provide information regarding authenticated or authorized Source(s) 130. In some exemplary embodiments, different Sources 130 may be authorized for different document types, for different requester entities, or the like. In some exemplary embodiments, Portal may retain webpages' characteristics of authorized source from which a document can be downloaded, such as Hyper Text Markup Language (HTML) page from which the document is downloaded, Document Object Model (DOM) of the webpage or elements therefrom, such as elements that are interacted with to initiate the download, a Secure Sockets Layer (SSL) certificate details of Source(s) 130, or the like. Additionally or alternatively, Portal may retain external-application characteristics of authorized sources that can be used to download documents. For example, external-application characteristics may comprise identifiers of authorized application repositories from which the external-application can be downloaded (e.g., AppStore™, Google Play™), parameters of an Application Package (APK) of the external-application (e.g., unique name, a size, version information, publisher information, or the like), a signature of the external-application, or the like.

In some exemplary embodiments, Portal may be configured to communicate with the user's ID-Application for specifying requested documents. Additionally, or alternatively, Portal may indicate to users, via ID-Application, a preferred website link from which the document should be downloaded. It is noted that in some embodiments, Portal may be implemented on ID-Server 150 instead of or in addition to Requester 110.

In some exemplary embodiments, ID-Server 150 may be a server that maintains a database. Additionally or alternatively, ID-Server may be a server that hosts a computer program utilized for managing and executing tasks of Downloading-System 100. ID-Server 150 may be able to communicate with a plurality of Devices 120, Source 130, Requester 110, or the like, via Network 140.

In some exemplary embodiments, ID-Server 150 may retain program code operative to perform acts associated with determining the authenticity of each downloaded document. In some exemplary embodiments, ID-Server 150 may retain program code and application operative to cause ID-Server 150 to perform acts associated with downloading immutable documents, as depicted in any of the steps in FIG. 2-4, or the like.

In some exemplary embodiments, ID-Server 150 may receive from ID-Applications executed on Device(s) 120

In some exemplary embodiments, ID-Server may be configured to collect from each Devices 120, of Downloading-System 100, metadata and other parameters of each downloaded document for determining its authenticity and that the document wasn't changed. In some exemplary embodiments, ID-Server 150 determines the authenticity of downloaded document by examining its signature and/or its metadata parameters with respect to characteristics of webserver hosting pages.

In some exemplary embodiments, the retained metadata and parameters information of each downloaded document information may be utilized, by ID-Server 150, for responding to a Portal's query regarding a specific document authenticity, such as by comparing current signature with stored signature.

In some exemplary embodiments, the information retained in the database of ID-Server 150, e.g., source webpages characteristics, metadata, and statistics, may be utilized for executing machine/deep learning algorithms used for determining preferred download method by ID-Application. In some exemplary embodiments, Device(s) 120 may report statistics on timing of download, time duration until the user commenced the download process and modality that was used (e.g., in-app browser or external-application), whether or not the download process has commenced (e.g., whether the user churned), whether the download process completed successfully (e.g., whether the modality employed was successful).

Additionally or alternatively, instead of a centralized data storage or in addition thereto, a distributed ledger (not shown) may be utilized to retain signatures of documents. The distributed ledger may be utilized to allow access to the information without requiring a central administrator. Additionally or alternatively, the distributed ledger may ensure that the retained signature remains unchanged without having to trust a central administrator.

Referring now to FIG. 2 showing a flowchart diagram of a method, in accordance with some exemplary embodiments of the disclosed subject matter.

It will be appreciated that a user of Device 120 may be able to download and install ID-Application directly from a website managed by ID-Server 150, or directed to that website by a requester of one or more documents. Additionally, or alternatively, the user may also be able to obtain the ID-Application from an application repository, such as AppStore™, Google Play™, or the like. In some exemplary embodiments, upon installation completion, the ID-Application may be authenticated and registered by ID-Server 150. Additionally or alternatively, Device 120 may maintain communication, via Network 140, with ID-Server 150 for utilizing services required by ID-Application for processing the methods of the present disclosure.

The flowchart of FIG. 2 depicts a method used to select a download method between a plurality of alternative downloading methods, representing alternative downloading modalities.

In Step 200, it may be determined that external-application-based downloading method is available for downloading a desired document. In some exemplary embodiments, the requester may define whether an external-application can be utilized to download the document and information relating thereto. The determination may be whether the external-application is technically available on the user device, such as installed thereon. Additionally or alternatively, the determination may be whether the installed and technically available external-application is authenticated.

In some exemplary embodiments, the authentication may be based on an application repository (also identified as package installer) from which the external-application was installed.

In some exemplary embodiments, a whitelist of allowed application repositories may be utilized to ensure that the package installer is acceptable. Additionally, or alternatively, a blacklist of unauthorized repositories may be utilized to ensure that the package installer is not among the unauthorized stores. Such a determination may ensure that the installed application is genuine and obtained from a credible source. For example, in case that the external-application was installed from an authorized application repository (e.g., official Apple™ AppStore™), the external-application may be trusted. If, instead, the external-application was installed from an unknown source, such as Hackers-R-Us™ store, the external application may not be trusted.

Additionally or alternatively, APK information of the external-application may be retrieved and compared for determining whether it can be trusted. For example, specific package name may be expected, specific versions may be allowed or disallowed (e.g., versions with known relevant vulnerabilities may not be trusted), specific package size may be expected to determine authenticity, publisher information may be examined, or the like. In some exemplary embodiments, a signature of the authorized external-application may be compared with the signature of the available external-application. In some exemplary embodiments, the signature of the external application may be made available by the authorized application repository. In some exemplary embodiments, the package signature may also be checked. The package signature may be compared to ensure that the package was not modified or otherwise is different than an original, authenticated version. Such methods and more may be utilized to determine whether the external-application installed by the untrusted user, and on the untrusted device, can be trusted to provide the correct document from the correct location and not to provide an alternative forged version of the document.

In Step 210, it may be determined whether in-app browser-based downloading method is available for downloading the desired document. In some exemplary embodiments, in-app browser-based downloading method may be available if the document can be downloaded via a web-based interface, such as via a website of the relevant source. In some exemplary embodiments, Portal may define a URL (or plurality of alternative URLs) from which the document can be downloaded. In case the URL is not defined, or if the web resource at the URL cannot be accessed (e.g., due to web server failure), the in-app browser-based downloading method may be considered as unavailable in advance. Additionally or alternatively, additional characteristics of the webpage may be compared with expected parameters. For example, the HTML page from which the document is to be downloaded may be stored and the HTML document at the URL may be compared thereto to indicate that the currently viewed version is authentic. Additionally or alternatively, DOM or elements in the DOM from which the document is to be downloaded may be retained and compared to ensure that similar elements exist in the webpage. Additionally or alternatively, SSL certificate of the source may be compared with the SSL certificate of the URL, such as to prevent Man in the middle attack or impersonation attempts. It is noted that such verification methods may be utilized to prevent attempts to provide a fake website that would look like that target source. As an example, by routing web requests via a malicious Domain Name Server (DNS), the domain name in the URL may be resolved to address to a different Internet Protocol (IP) address than that of the actual source. The disclosed subject matter may attempt to prevent such attacks.

In some exemplary embodiments, instead of performing the in-app browser validation or portion thereof a-priori, such measures may be performed after the in-app browser downloading method is selected and employed, in order to validate the downloaded document posteriori.

If after performing Steps 200 and 210, it is determined that a single modality is available, such modality may be selected on Step 230 without performing additional determinations. If both options are available, the disclosed subject matter may be employed to select therebetween.

In Step 220, outcome of utilizing each modality may be predicted. In some exemplary embodiments, the prediction may be founded on computation, by ID-Server 150 of FIG. 1, using machine learning, deep learning algorithms, or the like. In some exemplary embodiments, the prediction may be based on past metrics of downloading time and user interactions (e.g., clicks) that are required to be performed before completing the process. The prediction may be based on number of successful and unsuccessful downloading processes, number of users that churned from the process before initiating the downloading, or the like. Additionally, or alternatively, the prediction may be based on accumulated monitoring metrics taken during past downloads, such as conversion parameters, time elapsed metrics, number of interactions, types of interactions, and the like.

In Step 230, the preferred modality may be selected based on the predicted outcome(s) predicted in Step 220. In some exemplary embodiments, the selection may be biased to prefer solutions that allow quick downloading with minimal user interaction.

In Step 240, the selected modality may be utilized for downloading the document. In some exemplary embodiments, the selected modality may be an in-app browser modality, an external-application-based modality, or the like.

In Step 250, statistics may be collected from the user device and sent the system to be utilized thereby. In some exemplary embodiments, the statistics may be sent to ID-Server 150 of FIG. 1, or to another server. In some exemplary embodiments, the statistics may comprise monitoring metrics taken during the downloading process performed on Step 240, such as conversion parameters, time elapsed metrics, number of interactions, types of interactions, and the like.

In Step 260, the accumulated statistics transmitted from various devices on Steps 250 over time, may be utilized to train a predictor, such as using supervised learning or other training-set-based techniques. The predictor may be updated to be utilized in the future in performing Step 220.

Referring now to FIG. 3 showing a flowchart diagram of a method, in accordance with some exemplary embodiments of the disclosed subject matter. The flowchart of FIG. 3 depicts utilizing an in-app-browser-based downloading modality of a document.

In some exemplary embodiments, the in-app-browser option is designed to ensure that Source (e.g., 130 of FIG. 1) from which the document is downloaded is trusted and that the downloaded document was not tampered with. This may be performed without the cooperation of the third-party that provides Source 130.

In Step 300, a document source website may be browsed with in-app-browser of mobile application. In some exemplary embodiments, the in-app-browser may be used to open a webpage of Source 130. The webpage may be a webpage provisioned by the third-party source of the desired document.

In Step 310, a document download may be started. In some exemplary embodiments, the download may commence after the user performs an action which instructs the in-app-browser to download the document (e.g., clicks download a document hyperlink). In some exemplary embodiments, the file comprising the required document may be saved in user's vault (repository). In some exemplary embodiments, the in-app browser may be part of the ID-Application, and may be trusted. As a result, ID-Application may be aware of the location from which the document is downloaded, may control the location to which the document is directed after being downloaded (e.g., target folder), or the like.

In Step 320, metadata of the document that is downloaded may be recorded by ID-Application of Device 120. In some exemplary embodiments, the metadata may comprise the HTML page, DOM object from which the document was downloaded, DOM object interacted with in order to commence downloading, SSL certificate data of the source webpage from which the download performed, or the like. Additionally, or alternatively, the metadata may comprise screenshots of a webpage from which the download performed.

In some exemplary embodiments, the recorded metadata may comprise metrics related to conversion parameters, time elapsed metrics, number of interactions, types of interactions, and the like. In some exemplary embodiments, the number of interactions in the in-app browser may be counted and recorded. Additionally or alternatively, the time duration until the downloading commenced may be tracked. Additionally or alternatively, other metrics may be accumulated to be transmitted for statistical purposes (e.g., on Step 250 of FIG. 2).

In Step 325, it may be determined that the document was downloaded successfully. In some exemplary embodiments, the in-app browser may be configured to invoke an event once the download is complete, and such event may be acted upon.

In Step 330, the document may be authenticated. In some exemplary embodiments, after the download is completed, the recorded metadata may be matched with expected information, i.e., characteristics of Source 130 webpages, which were provided to ID-Application by ID-Server, by Portal, or the like. The downloaded document may be authenticated if recorded metadata match the expected information. In some exemplary embodiments, the expected information may be provided to ID-Application by ID-Server 150 prior to starting the download. In some exemplary embodiments, the comparison may be performed in advance and may be completed prior to the completion of the downloading process.

In some exemplary embodiments, in case the document is not authenticated, the downloaded document may be ignored. Additionally or alternatively, the document may be downloaded and retained, and an indication that it is not authenticated by the ID-Application may be retained. In some exemplary embodiments, such indication may be visible via a GUI of the ID-Application.

In Step 340, a signature of the document may be extracted. In some exemplary embodiments, following completion of download and the authentication, of Step 330, a digital signature may be computed. In some exemplary embodiments, the digital signature may be based on Secure Hashing Algorithm (HASH), Cyclic redundancy check (CRC), or any similar cryptographic application that can be used to sign the document. In some exemplary embodiments, each modification of the document would cause the signature that is extracted from the modified document to be different than the extracted signature of Step 340. It is noted that the signature may be extracted immediately after the document was downloaded, and before the user of the mobile device may modify the document. For example, signature may be extracted within 1 millisecond or less after the document download is completed. Additionally or alternatively, the signature may be extracted in an atomic operation that is performed together with releasing the document file to be modifiable by the operating system (e.g., before releasing a lock on the document). In some exemplary embodiments, using locking mechanism, it may be assured that no secondary process modifies the document before the signature is extracted therefrom.

In Step 350, the digital signature may be deposited in a server, such as a ID-Server 150, a distributed ledger, or the like. In some exemplary embodiments, the signature of each verified document may be communicated to the server and added to its database, i.e., authenticated documents library. Additionally or alternatively, recorded metadata may be transmitted to the server and retained thereby. The metadata may be utilized to improve selection of download modality in the future, for aggregating user-provided information, such as tags of files, or the like. In some exemplary embodiments, metadata of the document may be added and modified after download, and such modified information may be communicated to server.

In Step 360, the document may be saved in a vault of the user, such as local storage in Device 120 of FIG. 1, Storage 144 of FIG. 1, or the like. The document may be stored for uploading to the requester (e.g., 110 of FIG. 1). Additionally or alternatively, the document may be stored and re-used in the future, without requiring to re-fetch the same document from the original source.

In some exemplary embodiments, operators of Requester 110, for example, businesses or institutions that requested a document from a user, can authenticate the document based on the retained signature in the server. In some exemplary embodiments, a new signature of the uploaded document may be extracted and compared to the retained signature. It is noted that the comparison may be performed in different platforms. For example, the uploaded document can be transmitted to ID-Server 150, in which the signature can be extracted and compared to the retained signature. Additionally or alternatively, the requester may extract a signature and transmit the signature to ID-Server 150 to be compared with the retained signature of the document. As yet another example, the retained signature may be retrieved from ID-Server 150 or from the distributed ledger, and compared with the signature of the uploaded document. Such extraction and comparison may be performed, for example, entirely by Requester 110.

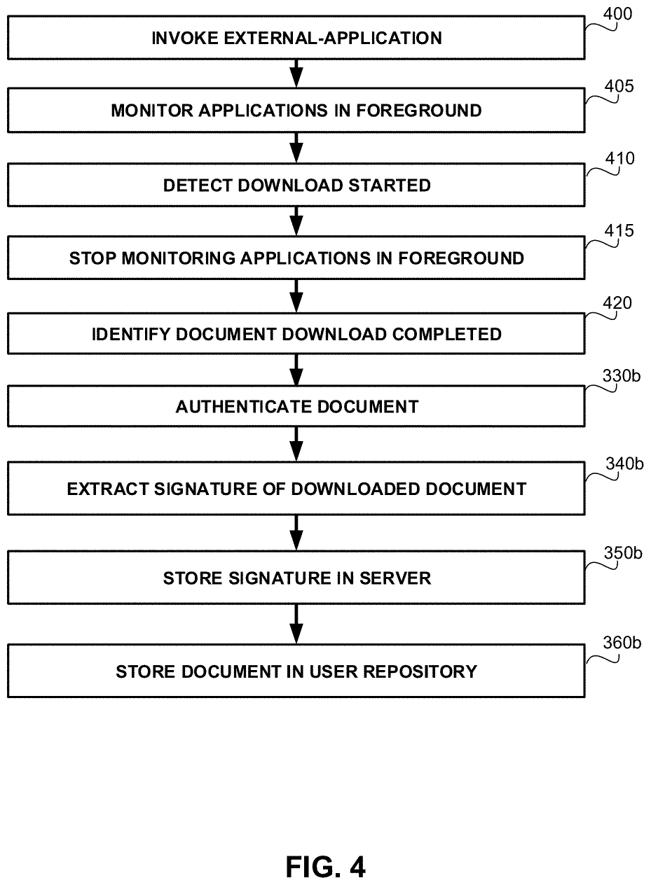

Referring now to FIG. 4 showing a flowchart diagram of a method, in accordance with some exemplary embodiments of the disclosed subject matter. The flowchart of FIG. 4 depicts a downloading process using an external-application.

In some exemplary embodiments, the external-application option may be designed to ensure the external application is trusted to obtain an authentic document and that the downloaded document was not tampered with during the download process or thereafter. This may be performed without the cooperation of the third-party that published or controls the external application, or the like.

In Step 400, the external-application may be invoked. In some exemplary embodiments, the external-application may be invoked by ID-Application to allow the user to obtain a requested document. In some exemplary embodiments, the external-application may be used to for downloading a document from a source, such as 130 of FIG. 1. In some exemplary embodiments, external-application may be a dedicated application of the third-party that is configured to perform functionality associated with the third-party, such as retrieve documents therefrom. In some exemplary embodiments, the external-application may be external to the ID-Application and may not be a generic application, such as a general file browser, web browser, or the like.

In some exemplary embodiments, upon invoking the external-application, ID-Application may validate that the executed external-application is indeed the same external-application that was authenticated in the method of FIG. 2. In some exemplary embodiments, the validation may comprise examining the external-application source, APK unique name, external-application signature, or the like.

In Step 405, monitoring of applications being utilized by the user may commence. In some exemplary embodiments, monitoring of the applications in the foreground may be implemented, such as using services of the Operating System. In some exemplary embodiments, during the monitoring, times in which each application is in the foreground may be recorded. In some cases, in view of privacy concerns, the recordation may only indicate at which time durations that external-application was in the foreground. In some exemplary embodiments, the monitoring of Step 405 may be commenced after the external-application is invoked (Step 400) and stopped once the download of the document starts (Step 415). Additionally or alternatively, the monitoring may be limited in time, such as for a duration of one minute, of ten minutes, or the like, thereby defining a limited maximal time window in which the monitoring is performed.

In some exemplary embodiments, as an example, in Android™, an AccessibilityService of Android™ operating system may be used for monitoring which application is in the foreground. AccessibiltiyService may be invoked in response to an event changing the application in the foreground of the device. It should be noted that it is possible that different applications may be moved to the foreground. In such cases, ID-Application may record which application is in the foreground and relevant timestamps.

In Step 410, a document download may be started. In some exemplary embodiments, after the user performs an action which instructs the external-application to download the document. In some exemplary embodiments, the file comprising the required document may be stored in a default location of Device 120. In some exemplary embodiments, it may be determined, either in Step 410 or later, e.g. Step 330b, whether the downloaded document was initiated by the external-application. As the user can manipulate the device, the user may attempt to utilize a different application to download a document. However, by monitoring applications in the foreground and correlating the download start time with the timing of the applications in the foreground, it may be determined which application initiated the download. Additionally or alternatively, it may be determined whether the download was initiated by the external-application or by another application.

In Step 420, it may be identified when the document download is completed. In response to such identification, Steps 330b and 340b, similar to Steps 330 and 340 of FIG. 3, may be performed before the user has a chance to modify the downloaded document. In some exemplary embodiments, the downloaded document may be locked and released only after completion of Steps 330b, 340b.

In some exemplary embodiments, identifying completion of the download that is initiated by the external-application may require utilizing of a technical mechanism. As opposed to the in-app browser-based modality, in which the in-app is internal to the ID-Application, in the external-application-based modality, the event of download completion is not naturally available to the ID-Application. In some exemplary embodiments, services of the Operating System may be employed to detect the event of file download completion.

In some exemplary embodiments, FileObserver in Android™ OS may be utilized for monitoring a folder into which the document is downloaded. In some exemplary embodiments, FileObserver may be utilized to listen and receive event relating to files, such as but not limited to CREATE, DELETE, MODIFY, OPEN, CLOSE, or the like. FileObserver may be utilized to determine the file is created and determine when the download is completed, such as when the file is closed. Additionally or alternatively, FileObserver may be utilized to ensure no additional process is writing to the same document, such as causing a MODIFY event, prior to performing Steps 330b, 340b, or the like.

Additionally, or alternatively, a DownloadManager service in Android™ OS may be utilized for monitoring when the download is completed. In some exemplary embodiments, DownloadManager may be a service of Android™ responsible to conduct the downloading of the document in the background. Events issued by DownloadManager may be intercepted and utilized to detect the completion of the download. In some exemplary embodiments, DownloadManager may be configured to issue notifications to the user via a status bar. The notifications may indicate when a download is completed, and its file name. In some exemplary embodiments, the notification in a status bar may be monitored to identify a notification that indicates the filename of the user initiated the download, as completed. In some exemplary embodiments, the file name identified in the notification can be utilized to distinguish between completion of the download of the document and completion of a download of another file.

It is noted that in Step 330b, the document may be authenticated similarly to the authentication performed In Step 330 of FIG. 3. In some exemplary embodiments, either during or after the download is completed, the downloaded document may be authenticated providing that the external-application was in the foreground and if the filename of the downloaded document is correct.

Referring now to FIGS. 5A-5D showing screenshots of a portal application, in accordance with some exemplary embodiments of the disclosed subject matter. The portal application may be a software application used by operators of businesses and organizations to bring information from multiple sources together, allowing content to be shared amongst a variety of departments, customers, and suppliers.

In some exemplary embodiments, the portal application may be configured to interface with Downloading-System 100 of the present disclosure for obtaining immutable digital documents. Additionally, or alternatively, the portal application may be configured to query documents signatures, as well as manage and archive the documents. In some exemplary embodiments, the portal application may be operated using a workstation, such as 112 of FIG. 1.

In some exemplary embodiments, FIGS. 5A-5D are showing screenshots of menu screens that provide access to functionalities associated with third-party document sources, such as Source 130, and users, such as users of Device 120.

FIG. 5A shows a Screenshot 500a depicting a data source selection menu. In some exemplary embodiments, the source selection menu may be used by the operator of the portal application for selecting a required document, e.g., get your UK Business registrations, from a Data Source Table 520a. In some exemplary embodiments, Data Source Table 520a may list sources of documents and information to be provided by the user to the requester entity. For example, the requester entity may request information as part of an onboarding process, as part of a due diligence survey of a client, or the like. Some sources of information may be obtained from a URL, others may be obtained using a dedicated HTML form, using a dedicated API, or the like.

In Screenshot 500a, the data source form, on the right, shows information relating to the data source that is presented in bold in Data Source Table 520a, which is presented on the left. In some exemplary embodiments, Input Field 505a indicates the name of the data source. The name may indicate an activity to be performed. Selection Field 510a indicates source type (e.g., URL, API, HTML, APP). Additionally or alternatively, Input Field 515a indicates the source URL address from which the document can be downloaded. Additionally or alternatively, Input Field 515a may be utilized to list an alternative set of URLs. Additionally or alternatively, the operator interacting with the portal application may visit the URL and record activity of downloading a document, which may be utilized to extract HTML file information, DOM elements, SSL information, or the like. Additionally or alternatively, such information may be provisioned in a manual or semi-manual manner. In some exemplary embodiments, Selection Field 510a may be utilized to select a plurality of integration types, such as indication both URL and APP. In some exemplary embodiments, URL may be utilized in an in-app browser-based download modality, while APP may be utilized in an external-application-based modality, where the portal application indicates the authorized external-application that can be utilized.

FIG. 5B shows a Screenshot 500b depicting a client information form to be utilized for defining a process of provisioning documents and information to the requester entity by a customer. Screenshot 500b shows the “company details” Step 590b within a Process 599, relating to Customer 580. In some exemplary embodiments, the company details step may include a step in which the operator may provide information regarding the customer from which information is requested. In some exemplary embodiments, Selection Field 520b may be used for selecting a product for which the document(s) and information are requested, e.g., loan application. After inputting the relevant information, the operator may click on Next Button 530b.

FIG. 5C shows a Screenshot 500c depicting an “Information Request” Step 590c within Process 599. The requested information may be addressed to the customer or to a third-party. In case the requested information is addressed to the customer, the disclosed subject matter may be employed, as the customer is requested to provision documents which may potentially be modified by the customer or otherwise forged or tampered with. The name (540c) and email address (542c) of the person who is requested to provide the information may be set by the operator. Additionally or alternatively, the documents that are requested may be selected from a list of documents, similar to that defined in Data Source Table 520a of FIG. 5A. As is indicated in the present illustration, Bank Transactions are requested via API (520c) and UK Business Registration is requested to be obtained via a URL (522c). Once the operator concludes the process, the operator may click on the Save & Send Button 530c. The request may then be transmitted to the user, as defined in the process (e.g., in field 542c).

In some exemplary embodiments, a document request email to users comprises a link for activating the ID-Application. Additionally or alternatively, in case the application is not installed on the user device, the link may enable downloading the ID-Application. In some exemplary embodiments, once ID-Application is launched, information regarding requested documents and information may be shown to the user, based on the definitions provided by the operator via the portal application.

FIG. 5D shows a Screenshot 500d depicting a document checklist menu of a customer. In some exemplary embodiments, the checklist menu may comprise a status table of documents and information requested from Customer 580, such as defined in Process 599. As an example, in the present illustration, Bank Transactions 520d and UK Business Registrations 522d were requested directly from the customer (e.g., an addressed to “yuval”). In some exemplary embodiments, Column 523d indicates the document status, e.g., pending or uploaded, and Column 524d indicates if the uploaded document was validated.

In some exemplary embodiments, FIGS. 6A-6D are showing screenshots of GUI that provide the user of Device 120 with access to functionalities and visibility to ID-Application and the user's vault.

In some exemplary embodiments, FIG. 6A depicts a Screenshot 600a indicating names of requested documents to be downloaded, e.g., UK Business Registrations (Requested Document 622), or other information to be provisioned to the requester entity. In some exemplary embodiments, the GUI depicted in screenshot 600a, provides users with button, such as Take-Photo Button 630, Choose-File Button 635, Browse Button 640, and Vault Explorer Button 650, used for instructing ID-Application to perform actions.

In some exemplary embodiments, Take-Photo Button 630 may activate a camera of the device, to be used for taking photos to be stored and potentially provisioned to third parties, such as requester entity. As an example, the user may take a photo of her driver license.

In some exemplary embodiments, Choose-File Button 635 may enable the user to select a pre-saved document from the vault for sending it to a document requester. Such feature may be useful for reusing previously downloaded documents and avoiding to perform multiple downloads of the same document by the user for different requesters, as may be the case when the user applies for a service with multiple alternative vendors (e.g., requests a mortgage loan from several banks).

In some exemplary embodiments, Browse Button 640 may initiate the downloading of the document in accordance with the disclosed subject matter. In response to pressing Browse Button 640, the method of FIG. 2 may be performed, for obtaining the document indicated in Document Request 622. In the illustrated example, the document may be obtained using the in-app browser-based modality.

In some exemplary embodiments, Vault Explorer Button 650 may enable the user to explore the documents stored in her vault.

In some exemplary embodiments, FIG. 6B depicts a Screenshot 600b shows the in-app browser being utilized. In the present example, the in-app browser has a visible Address Bar 611b, which may or may not be utilized by the user to input a different URL.

The in-app browser may fetch from the URL the web page, such as represented using an HTML file. The retrieved HTML file may be compared with a skeleton/template HTML file that is expected to be encountered. Additionally or alternatively, the user may interact with a GUI element within the HTML file, such as Hyperlink 612b, utilized for downloading a Portable Document Format (PDF) document from the website. In some exemplary embodiments, Hyperlink 612b may be represented by a DOM element within the DOM file of the webpage.

In some exemplary embodiments, FIG. 6C depicts a Screenshot 600c showing an Icon 625c representing that a document has been downloaded, for example, as a result of instructing, using Browse Button 640 and via the in-app browser, to download Requested Document 622.

In some exemplary embodiments, Indicator 627c may be displayed to provide indication as for the validation of the downloaded document. As an example, different coolers may be utilized. In some exemplary embodiments, green indication may indicate that the document is validated. Additionally or alternatively, red indication may indicate that the document was invalidated. In some exemplary embodiments, a yellow indication may be indicative that the validation process was inconclusive (does not validation nor invalidate the document). Additionally or alternatively, a yellow indication may indicate that no validation was performed, such as in view of the operator not providing, via the portal application, information useful for validation. In some exemplary embodiments, the yellow indication may indicate that the document may be used at the discretion of the requester entity.

In some exemplary embodiments, Button 629c may be utilized to add another file in response to the Document Request 622. The additional file may be another, different file, or another copy of the same document, such as obtained in a second attempt to provide a validated document.

In some exemplary embodiments, FIG. 6D depicts a Screenshot of 600d showing documents, such as Document 660, stored in the user's vault. In some exemplary embodiments, the user may view documents in the vault, may delete such document, may select document to be provisioned in response to a request to receive documents, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
downloading a document from a source to a device;
in response to a determination that said downloading of the document is completed, calculating a signature of the document; and
depositing the signature to a server,
whereby any modification to the document is identifiable using the signature that is retained by the server.

2. The method of claim 1, wherein the device is a mobile device retaining a mobile application, wherein said downloading is performed using an in-app browser of the mobile application.

3. The method of claim 2 further comprises authenticating the document using a parameter of the source, wherein the parameter is selected from the group consisting of:
a parameter of a Secure Socket Layer (SSL) of the source utilizing in said downloading;
a parameter of a Hypertext Markup Language (HTML) document from which said downloading is initiated; and
a parameter of screenshots of a webpage from which said downloading is initiated.

4. The method of claim 1, wherein the device is a mobile device retaining a mobile application, wherein the method further comprises:
in response to a determination that a valid external-application is not available on the mobile device for performing said downloading, utilizing an in-app browser of the mobile application for performing said downloading.

5. The method of claim 1 further comprises authenticating the download process, wherein said authenticating comprises:
obtaining one or more expected parameters of the download process;
obtaining one or more parameters of the download process; and
verifying that the one or more parameters match the one or more expected parameters.

6. The method of claim 1, wherein the device is a mobile device retaining a mobile application, wherein the method further comprises:
determining, by the mobile application, that an external-application is installed on the mobile device, wherein the external-application is different than the mobile application, wherein said determining is based on a list of allowed external-applications;
in response to said determining, validating the external-application; and
in response to successful validation of the external-application utilizing the external-application for performing said downloading.

7. The method of claim 6, wherein said validating the external-application is based on at least one of:
an application repository from which the external-application was retrieved to the mobile device;
parameters of an Application Package (APK) of the external-application; and
a signature of the external-application.

8. The method of claim 6 further comprising:
initiating monitoring of activity in the mobile device using one or more services of an operating system of the mobile device, wherein the monitoring activity comprises:
recording application at foreground of the mobile device and times thereof;
identifying time of start of downloads in the mobile device; and
determining which application was at the foreground when said downloading was started to verify that said downloading was initiated by the external-application.

9. The method of claim 6, wherein the determination that said downloading of the document is completed is determined based on monitoring FileObserver status.

10. The method of claim 1, wherein the device is a mobile device retaining a mobile application, the method further comprises:
selecting downloading method between an in-app based-downloading method and an external-application-based downloading method, wherein the in-app based-downloading method comprises downloading the document using an in-app browser of the mobile application, wherein the external-application-based method comprises downloading the document using an external-application that is external to the mobile application, wherein said selecting is based on a prediction of expected successful completion time using each alternative downloading method.

11. The method of claim 10, wherein said selecting is performed using a predictor, wherein the predictor is based on historic outcomes of past downloading attempts, wherein the method further comprises transmitting information to a remote server for gathering training dataset for training the predictor using supervised machine learning.

12. The method of claim 1, wherein the server is a distributed ledger, whereby the signature is accessible without requiring authorization of a central administrator.

13. A system comprising:
a server comprising a memory unit;
at least one mobile device, each of which comprising a processor and a memory unit; and
a client device comprising a processor;
wherein said at least one mobile device utilizing a mobile application for obtaining a signature of a document at a time in which the downloading of the document is completed, wherein the mobile application is configured to send the signature to the server to be retained therein;
wherein said client device is configured to obtain a second signature of a document received from said at least one device; and
wherein the system is configured to compare the signature with the second signature to verify that the document was not modified.

14. The system of claim 13, wherein the mobile application is configured to download the document using an in-app browser of the mobile application, wherein the mobile application is configured to verify authenticity of the document based on one or more parameters relating to a source of the document from which the document is downloaded.

15. The system of claim 13, wherein said at least one mobile device retaining an external-application external to the mobile application, wherein the external-application is provided by a publisher independent of a publisher of the mobile application, wherein the mobile application is configured to utilize one or more services of an operating system to monitor activity at said at least one mobile device to verify that the external-application is used to download the document.

16. The system of claim 15, wherein the mobile application is configured to utilize the one or more services of the operating system to:
identify and record application at foreground of said at least one mobile device and times thereof;
identifying time of start of downloads in said at least one mobile device;
wherein the mobile application is configured to determine which application was at the foreground when said downloading was started to verify that said downloading was initiated by the external-application.

17. A mobile application comprising a non-transitory computer readable medium retaining program instructions, which instructions when read by a processor of a mobile device, cause the processor to perform:
in response to a determination a downloading of a document is completed, calculating a signature of the document; and
depositing the signature to a server,
whereby any modification to the document is identifiable using the signature that is retained by the server.

18. The mobile application of claim 17, wherein the mobile application comprising an in-app browser, wherein the in-app browser is utilized to download the document from a source.

19. The mobile application of claim 17, wherein the program instructions, when read by the processor, cause the processor to perform:
selecting downloading method between an in-app based-downloading method and an external-application-based downloading method, wherein the in-app based-downloading method comprises downloading the document using an in-app browser of the mobile application, wherein the external-application-based method comprises downloading the document using an external-application that is external to the mobile application, wherein said selecting is based on a prediction of expected successful completion time using each alternative downloading method.

20. The mobile application of claim 17, wherein the program instructions, when read by the processor, cause the processor to perform:
determining that an external-application is installed on the mobile device, wherein the external-application is different than the mobile application, wherein said determining is based on a list of allowed external-applications;
in response to said determining, validating the external-application, wherein said validating the external-application is based on at least one of:
an application repository from which the external-application was retrieved to the mobile device;
parameters of an Application Package (APK) of the external-application; and
a signature of the external-application; and
in response to successful validation of the external-application utilizing the external-application for performing said downloading.
